(19) United States
(12) Patent Application Publication
(10) Pub. No.: US 2011/0067279 A1
(43) Pub. Date: Mar. 24, 2011

(54) Expanding Advertising

(76) Inventor: Armando DOS SANTOS CAMACHO, Pennant Hills (AU)

(21) Appl. No.: 12/951,755

(22) Filed: Nov. 22, 2010

Related U.S. Application Data
(63) Continuation-in-part of application No. PCT/AU2009/000643, filed on May 22, 2009.

(30) Foreign Application Priority Data
May 22, 2008 (AU) 2008902524
Sep. 25, 2008 (AU) 208904981
Sep. 1, 2010 (AU) 2010903924

(51) Int. Cl. G09F 15/00

(52) U.S. Cl. 40/601

(57) ABSTRACT

An advertising device (150) for a vehicle has at least one panel (160) that carries advertising material, the device (150) having a first, closed configuration, in which the panel (160) is substantially hidden and an open position in which the panel (160) is substantially visible. The device (150) has a bottom member (152) and a top member (154) and the panel extends between the top and bottom members (152, 154) within their perimeter to form a relatively airtight volume. A fan (162) creates a low pressure in the volume during closure so the panel (160) is drawn inwards as the device (150) is closed and does not extend beyond the perimeters of the top and bottom members (152, 154).

### CROSS-REFERENCES TO RELATED APPLICATIONS

This is a continuation-in-part of international application PCT/AU2009/000643, filed May 22, 2009, which designated the United States. International application PCT/AU2009/000643 itself claimed priority to Australian application 2008902524, filed May 22, 2008, and Australian application 208904981, filed Sep. 25, 2008. Applicant hereby claims the right of priority and the benefit of these earlier-filed applications under 35 U.S.C. §120 and/or 365(c).

### FIELD OF INVENTION

This invention relates to advertising and display material and more particularly to roadside advertising. However the invention is not limited to roadside advertising.

### BACKGROUND

Many businesses are located in a shopping strip, area or the like so as to be conveniently located for customers. Ground floor shops command a rental premium and many service businesses, such as dentists and medical practitioners utilise first floor space above ground floor retail outlets. Whilst the rent may be less, their presence at ground level is low. As such even when there is a reasonable amount of passing traffic, potential customers are unlikely to be aware of the existence of the business merely walking in the shopping area and so customers are usually sourced by word of mouth or other advertising means, such as telephone directories, adverts in local newspapers and the like.

Vehicle mounted advertising has been proposed but is usually permanently displayed or needs to be removed before driving the vehicle. Advertising that is permanently displayed has the advantage of not needing any setup time. However it suffers the drawback of making the vehicle a permanent advertising platform. Many small business owners may be willing to use their personal car for advertising during working hours but do not want to do so at other times. In addition a permanent display may create extra wind drag whilst driving and, if attached to a tall vehicle, may limit where the vehicle can go. In addition, in some jurisdictions such advertising structures may be illegal whilst driving.

Removable advertising does not have the disadvantage of always being on display but has the drawback of requiring the user to install and uninstall the advertising material. Unless it is a relatively easy and quick job to do, potential users are not interested.

### SUMMARY OF THE INVENTION

The present invention aims to overcome at least one of the above disadvantages by providing a display device for a vehicle, including at least one panel that carries display material, hereinafter referred to as advertising material, the device having a first, configuration, in which the advertising material is substantially hidden and in which substantially all of the device lies relatively close to the vehicle and a second configuration in which the advertising material is substantially visible.

The advertising device may be mounted on the roof of a vehicle (or roof racks) and may extend upwards in the open configuration. The device may also be mounted on a trailer, such as a box or flatbed trailer.

The advertising device may have a first movable member to which the at least one panel is attached, the movable member being in a first position in the first configuration and a second position in the second configuration.

The device may have a second member with the at least one panel extending between the first and second members. In the first configuration the members may define an enclosure in which the at least one panel is located. The enclosure may be substantially sealed. One or both of the members may be tub shaped, with a base and side walls.

The device may be substantially or generally sealed and the at least one panel may be flexible. The device may also include a mechanism, such as a fan, that generates a lower pressure within the device so as to cause the flexible member to be caused to flex inwards. Preferably the lower pressure is generated when the device configuration is being changed from the second (open) configuration to the first (closed) configuration but may be generated whilst the device is in the second configuration to maintain the flexible member taut.

In one form the second member is adapted to be mounted on an existing roof of a vehicle or on a trailer. In another form the second member is adapted to form a roof for a roofless vehicle.

The device may include expanding means, to expand the device from the first to the second configuration. The expanding means may be a biasing means that expands and holds the device in the open position. The expanding means may include at least one inflatable bladder. The expanding means may be at least one spring. Where at least one inflatable bladder is utilised the device may include means to inflate the bladder(s), such as a compressor.

The at least one panel may be part of the at least one inflatable bladder.

The expanding means may include one or more movable arms, which move from a first position to a second position to change the device from the first to the second configuration. The movable arm(s) may include scissored arms that extend between the two members of the device.

The device may include collapsing means to collapse the device from the second to the first configuration. The collapsing means may include one or more ropes, cords, strings or the like that is connected to the first member, whereby first member may be drawn toward the first position. Where a mechanism, such as a fan, that generates a lower pressure within the device is provided, this may also serve as a collapsing means.

The device may have two or more self supporting panels. This may be achieved by adjacent panels supporting each other. In one form in the open position, side edges of adjacent panels are connected to each other. This may be by way of zippers, hook and loop fastener material, press studs or other fasteners.

In another broad form the invention provides an advertising device including:
a base member having a bottom perimeter;
a top member having a top perimeter;
at least one flexible display panel attached to the top and bottom members adjacent the first and second perimeters so as to extend between the top and bottom members;
a lift mechanism operable to move the top and bottom members between an open position in which at least a part of the top member is spaced from the bottom member and a closed position in which said at least a part of the top member is adjacent the bottom member;
the at least one flexible display panel defining at least part of a relatively airtight volume having an interior;
an air extractor in fluid communication with the interior and operative to extract air from the interior and create a low pressure in the interior to draw or maintain the at least one flexible display panel within a second volume defined by a surface extending from the top perimeter to the bottom perimeter as the top and bottom members are moved from the open position to the closed position.

The volume may be defined in part by at least one of the top member and the bottom member. Alternatively the at least one flexible display panel may define all or substantially all of the volume.

The top member may include a top portion with a top perimeter wall defining the top perimeter extending from the top portion toward the bottom member.

The bottom member may include bottom portion with a bottom perimeter wall defining the bottom perimeter extending from the bottom portion toward the top member.

In the closed position the top perimeter wall may extend around the bottom perimeter wall to define a substantially closed box.

The top and bottom perimeters are preferably substantially the same.

The top member may include a generally planar top portion. The bottom member may include a generally planar bottom portion.

The top and bottom members preferably move between open and closed positions by relative linear motion. However, the top and bottom members may move between open and closed positions by relative motion about an axis.

The lift mechanism may comprise a scissor lift.

Preferably in the open position all or substantially all of the at least one flexible display panel extending between the top and bottom members is held taut by the top and bottom members.

The at least one flexible display panel is preferably attached to the top and bottom members within the top and bottom perimeters.

The advertising device may include:
a bottom member;
a top member;
the bottom member having a bottom portion with a bottom perimeter wall defining a bottom perimeter extending from the bottom portion toward the top member;
a top member having a top portion with a top perimeter wall defining a top perimeter extending from the top portion toward the bottom member;
at least one flexible display panel attached to the top and bottom members adjacent the top and bottom perimeter walls so as to extend between the top and bottom members;
a scissor lift mechanism operable to move the top and bottom members between an open position in which at least a part of the top member is spaced from the bottom member and a closed position in which said at least a part of the top member is adjacent the bottom member;
the at least one flexible display panel and the top and bottom portions defining at least part of a relatively airtight volume having an interior;
an air extractor in fluid communication with the interior and operative to extract air from the interior and create a low pressure in the interior to draw or maintain the at least one flexible display panel within a second volume defined by a surface extending from the top perimeter to the bottom perimeter as the top and bottom members are moved from the open position to the closed position;
wherein in the open position all or substantially all of the at least one flexible display panel extending between the top and bottom members is held taut by the top and bottom members.

The device in preferred forms has the panels extending vertically, either upwards or downwards. However the device may be configured so the panel or panels extend horizontally in the open position or both vertically and horizontally. The panels may extend along or across the vehicle.

The foregoing optional features of the invention may be combined in any combination of features where features are not mutually exclusive.

These and other features of the invention shall be apparent from the following non-limiting description of embodiments shown in the accompanying drawings.

### BRIEF DESCRIPTION OF THE DRAWINGS

FIG. 1 shows a perspective view of a vehicle carrying an advertising device according to a first embodiment of the invention in a collapsed state.

FIG. 2 shows a perspective view of the vehicle of FIG. 1 with the advertising device in a raised state.

FIG. 3 shows an axial cross sectional view of a first raising mechanism for the first embodiment.

FIG. 4 shows an axial cross sectional view of a second raising mechanism for the first embodiment.

FIG. 5 shows a perspective view of a vehicle carrying an advertising device according to a second embodiment of the invention in a raised state.

FIG. 5A shows a perspective view of a vehicle carrying an advertising device according to a variation of the invention in a raised state.

FIG. 6 shows a perspective view of a vehicle carrying an advertising device according to a third embodiment of the invention in a raised state.

FIG. 7 shows a perspective view of a vehicle carrying an advertising device according to a fourth embodiment of the invention in a raised state.

FIG. 8 shows a perspective view of an advertising device according to a fifth embodiment of the invention.

FIG. 9 shows an end view of the fifth embodiment of the invention.

FIG. 10 shows an end view of a sixth embodiment of the invention.

FIG. 11 shows a plan view of the sixth embodiment of the invention.

FIG. 12 shows a cross sectional view of a seventh embodiment of the invention in an erected position.

FIG. 13 shows a cross sectional view of the seventh embodiment of the invention in a part closed position.

FIG. 14 shows a cross sectional view of the seventh embodiment of the invention in the fully closed position.

### DETAILED DESCRIPTION OF PREFERRED AND OTHER EMBODIMENTS

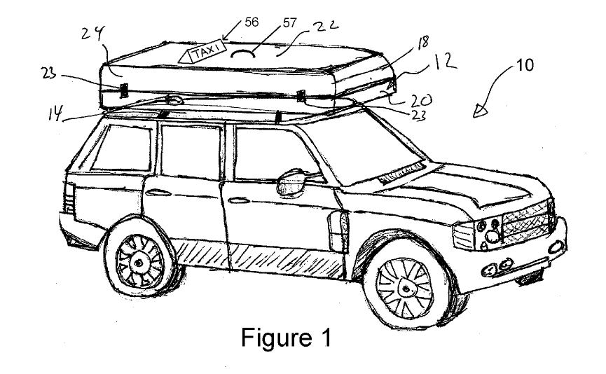

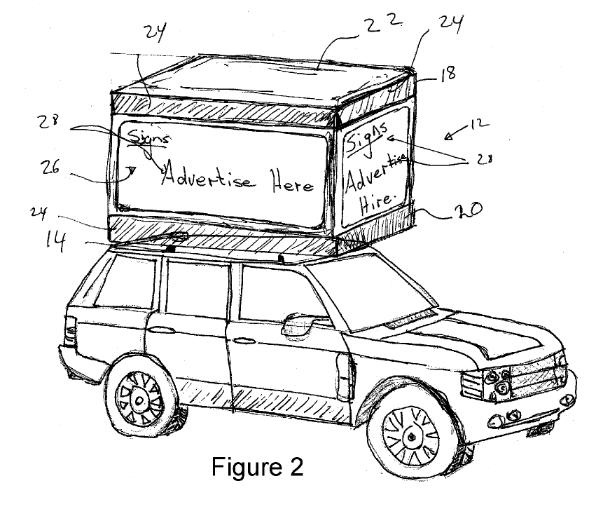

Referring to FIGS. 1 and 2 there is shown a vehicle 10 carrying an advertising device 12 according to a first embodiment of the invention.

The advertising device 12 is mounted on a roof rack 14 mounted to the vehicle 10, but may incorporate suitable mountings to attach directly to the vehicle.

In the first embodiment the advertising device 12 comprises a clam shell case or cover 16 having upper and lower parts 18 and 20 respectively. Each part 18, 20 has a base 22 and surrounding side walls 24.

The case has a closed configuration, shown in FIG. 1, in which the upper part 18 is close to or engages the lower part 20 and an open configuration, shown in FIG. 2, in which the two parts are separated. The two parts 18, 20 are not hinged together but remain generally parallel to each other in the open position. In the closed position the two parts may be retained together by clips 23 or the like so as to present a short and relatively slim case on the roof of the vehicle. The closed configuration thus does not extend the vehicle's overall height any more than a conventional roof box or roof tray.

Attached to the upper and lower parts 18, 20 are advertising panels 26. These panels are flexible and may be formed of a fabric or plastics sheet or the like. The panels carry advertising material 28 on their surface. The panels are located within the two parts 18, 20 and extend between the two parts inside of the side walls. When closed the panels 26 fold within the case and are not exposed or visible. Thus in the closed configuration the vehicle may be driven with a relatively short box or case like structure on its roof with relatively little wind drag and without it being apparent that the case carries advertising material. Thus there are no issues for the driver or the authorities regarding advertising material or the structure whilst driving.

The vehicle may thus be driven, for example, from the driver's home, with the case closed, to the driver's place of work. The vehicle is parked and the driver releases the catches 23, allowing the upper part 18 to rise (as explained later) upwards relative to the lower part 20. This draws the advertising panels 26 to a vertical configuration where they are visible to passing persons. The vehicle may be left with the advertising showing during the day. When the driver wishes to leave, the upper part 18 is lowered to close the case, hiding the advertising material, the clips 23 are closed and the vehicle driven off.

Raising and lowering of the upper part preferably takes in the order of one minute, but this is not critical to the invention. Various means of raising and lowering the upper part may be used.

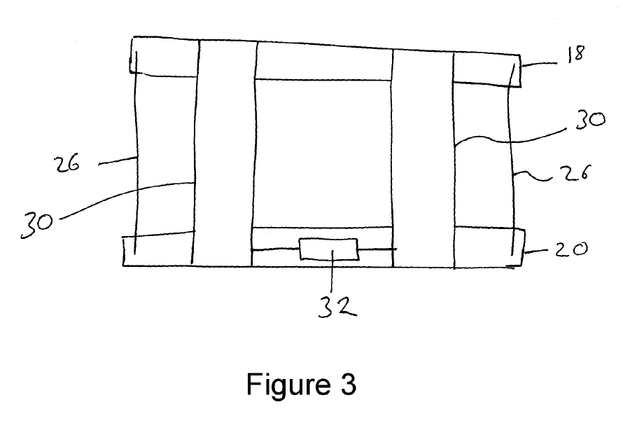

As shown in FIG. 3, one or more pneumatic bladders 30 may be placed between the upper and lower parts 18, 20, with an onboard compressor 32 expanding the bladders to raise the upper part. Once expanded the bladders may be sealed by valves (not shown) in the inflated state. Alternatively the compressor may be activated by suitable sensors to maintain the bladders within a preset range of pressures to maintain the bladders inflated. When the time comes to close the case, the valves are opened, allowing the bladders to deflate and lower the upper part 18.

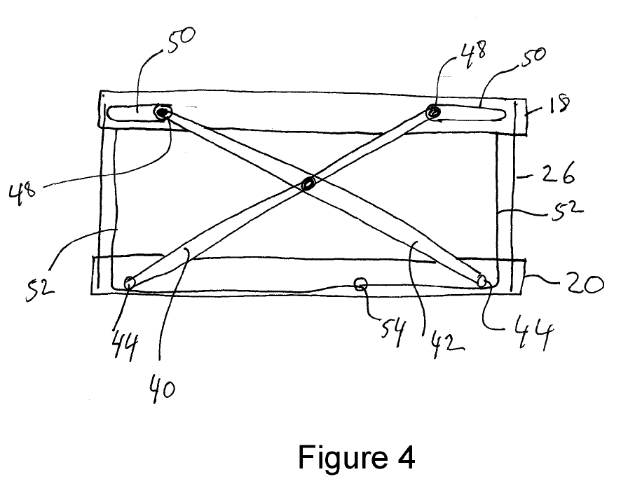

A scissor arrangement, such as shown in FIG. 4, may be used. Scissor arms 40, 42 are pivotally mounted on the lower part 20 at pivot points 44 and to each other at 46. The upper ends 48 slide in slots 50 on upper part 18. The slots may have locking means to retain the arms in the raised position. The upper part may be manually raised and lowered by manipulating the upper part 18. Although a single pair of arms are shown it will be appreciated that a scissor lift having multiple pairs of arms arrange end on end may be used. Alternatively, the device may have a raising means, such as a spring or a sealed pneumatic bladder that raises the upper part.

When a spring or bladder is used to raise the upper part, lowering of the upper part may be assisted by use of cords 52 that extend from the upper part to the lower part and exit via opening 54. The upper part may be lowered by pulling on the cords 52.

The device according to the first embodiment may be used with a Taxi and provided with a conventional “Taxi” sign 56 that is mounted on the top of the case. The taxi sign is used to indicate to potential customers the availability or other wise of the taxi for hire. During normal taxi operations the vehicle is driven with the case closed. When the vehicle is parked the case may be expanded as described before.

The device 12 may also have one or more storage hooks or loops 57 attached to the upper part 18. The user may drive the vehicle into a garage with the device 12 attached to the car in a lowered state. The device 12 is raised and one or ropes, cables or other supports connected to the loop(s) 57 so as to support the device. The device 12 is detached from the vehicle and the lowering mechanism, such as the scissor mechanism or bladders previously described moved to the lowered position. However, because the upper part 18 is supported and cannot lower, this raises the device from the vehicle for storage. The vehicle may then be driven away without the device.

Placement on the vehicle is the reverse of the above procedure.

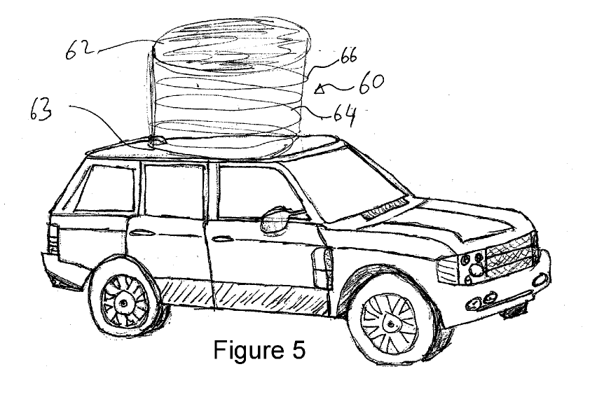

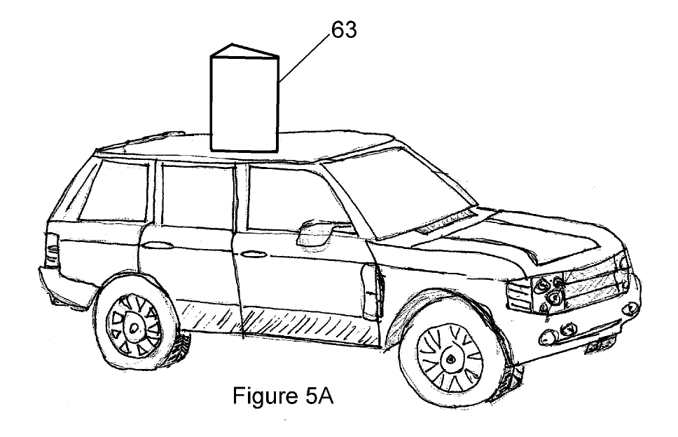

An expandable advertising device 60 according to second embodiment of the invention is shown in FIG. 5. The device 60 is mounted on a vehicle 61 and comprises an expandable cylinder having top and bottom walls 62, 63 and side wall 62. The side wall carries advertising material. The device may move between a closed position (not shown), in which the top and bottom walls are close together adjacent the vehicle's roof and an open position, as shown in FIG. 5. The top wall 62 may be raised by an internal coiled spring, 66. Lowering occurs by pushing down on the top wall or by use of internal cords, in a manner similar to that shown in FIG. 4.

The device may be shapes other than a cylinder and may be a polygon, such as a triangle, rectangle, square, pentagon etc. The device may have more than five sides. FIG. 5A shows a triangular device 63 on a vehicle.

The device 60 may be a pneumatic bladder that is expanded by a compressor (and deflated) in a similar manner to that shown in FIG. 3.

The top wall may be stiff whilst the side wall is preferably flexible fabric or the like.

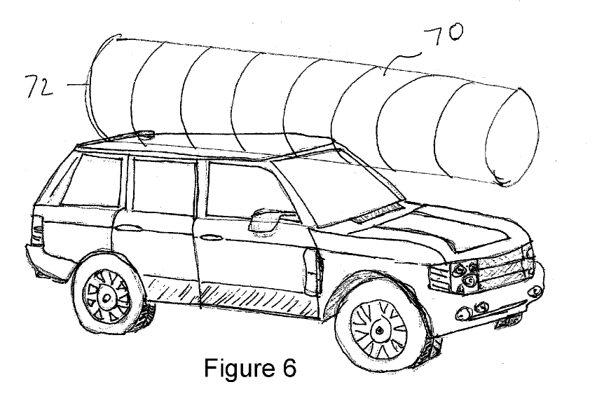

FIG. 6 shows an advertising device 70 similar to that of FIG. 5 but instead of extending upwards the device extends along the roof of the vehicle. In this situation the base 72 is affixed to the vehicle or roof racks whilst the other end 74 is free. The device may be pivotally mounted on the vehicle so that when closed the device may be laid as a disc or short cylinder extending a small amount upwards. The lower part of the device may include lugs that engage in a horizontal guide rail (not shown) running lengthways along the vehicle to retain the extended device in the orientation shown.

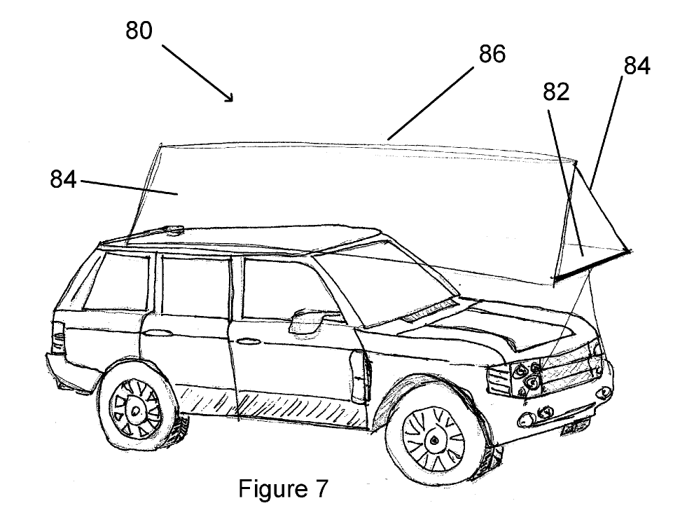

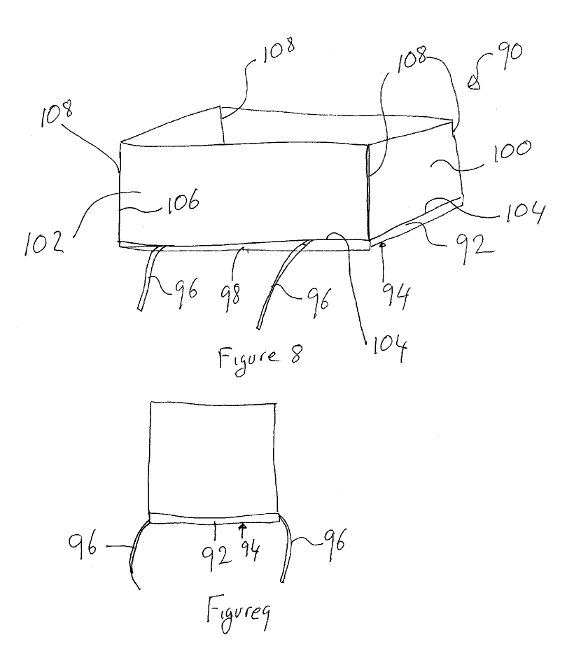

FIG. 7 shows a fourth embodiment of the invention comprising an elongate triangular advertising device 80. The device 80 is mounted on the vehicle or roof racks and two side walls 84 that meet at ridge line 86. The two side walls 84 carry advertising material. The device 80 may be similar to the device of FIG. 6 in expanding along a horizontal axis from a collapsed state to the expanded state as shown in the drawing. Alternatively, the device 80 may have internal supports or the like that raise the ridge line 86 upwards from the base 82. These struts may be pneumatic bladders, telescoping or folding members or other suitable raising means. Bladders may be incorporated into the side walls 84. To collapse the device these supports are lowered, bringing the ridge line 86 to lie against the base 82. Fasteners maybe provided to enable the two side walls 84 to be folded and secured to each other or the base 82. As an example, one side wall 82 may have one half of a zipper running along its length that engages with the other half of the zipper running along or next to the junction of the side wall and the base 82.

Referring to FIGS. 8 & 9 there is shown an advertising device 90 according to a further embodiment of the invention. The device 90 has a base 92 that is intended to be placed directly on the roof of the vehicle (not shown). The underside 94 of the base 92 is, accordingly, a material or fabric that will not damage the vehicle. The base 92 may be rigid or may be flexible.

The device is attached to the vehicle using straps 96 that are attached to the longitudinal sides 98. These are each provided with buckles for attachment to a corresponding strap extending from the other side and are length adjustable.

The straps are passed through the open windows of the vehicle, joined together and then tightened to firmly hold the device to the roof of the vehicle. The windows may then be raised to be closed or substantially closed.

Mounted on the base 92 are end panels 100 and side panels 102 intended to carry advertising. The panels are attached to the base along their bottom edges 104 and may fold about this join between a raised position, as shown, and a folded position, in which the panels lie horizontally over the base.

The adjacent edges 106 of the panels are provided with a zipper 108. Each edge has one half of the zipper. When vertical the edges 106 of adjacent panels extend next to each other vertically and may be connected to the adjacent panel using the zipper. Once connected the zippers prevent the panels folding down. To fold down the panels the zippers are undone, so allowing each panel to fold independently of the adjacent panels and folded to the horizontal position.

FIGS. 10 & 11 show a device 108 being a further embodiment of the invention, comprising a base 110 similar to the base 92 of FIGS. 8 & 9 intended to be placed on the roof of a vehicle (not shown). The base has two side panels 112 that carry advertising. The panels 112 are intended to hang down from the roof of the vehicle rather than extend upwards. Accordingly, each panel 112 has straps 114 for connection to straps on the other panel to secure the device to the vehicle and prevent the panels 114 moving significantly with the wind or other airflows. These may pass under the vehicle to be connected to each other. If desired the base 110 may be provided with straps as in the FIGS. 8 & 9 embodiment that are passed through the vehicle cabin to secure the base top the vehicle.

All of the embodiments may be provided with integral, internal or external lighting. As examples, LED strip lighting may be attached to the fabric of the device, either internally or externally. LED strip lighting is relatively flexible and does not occupy much space and so does not significantly affect the ability to collapse the devices to a relatively low profile. The fabric of the device may be “self illuminating”. One such self illuminating fabric is that sold under the brand Luminex (http://www.luminex.it/) that is created with fibre optic threads and may emit light in different colours. A flashing light may also be provides to draw attention to the advertising or the vehicle. If desired a sound source may also be provided.

If desired the device may be provided with panels that allow light to pass. The panels may be plain (free of advertising) and may serve to diffuse light from light sources within the device. If desired the panels may be translucent or transparent.

If desired the device may be provided as a simple collapsible lighting device, with light sources located between the base and the top and there being no panels. When collapsed the light sources are contained within the device and protected from the environment. When expanded the light sources are available to illuminate the environment around the device.

When used to advertise a shop or other promises a separate sign may also be provided to point viewers toward the premises. Thus, for example, a separate sign with an arrow may be provided that may be attached to the device so as top point toward the premises.

The preferred forms of the invention are intended to be mounted on a vehicle with an existing roof and, generally, have a base that is adapted to be mounted on the roof of the vehicle or roof racks or the like. However, the invention also includes devices for use with vehicles that have no roof or in which the roof is replaced by the device of the invention.

One such example is a device for a golf buggy. Golf buggies typically have a plastics roof mounted of a framework. In one form the device may be provided with a base unit that is adapted to replace the existing roof of a golf buggy and is adapted to mount on the framework, rather than on the roof.

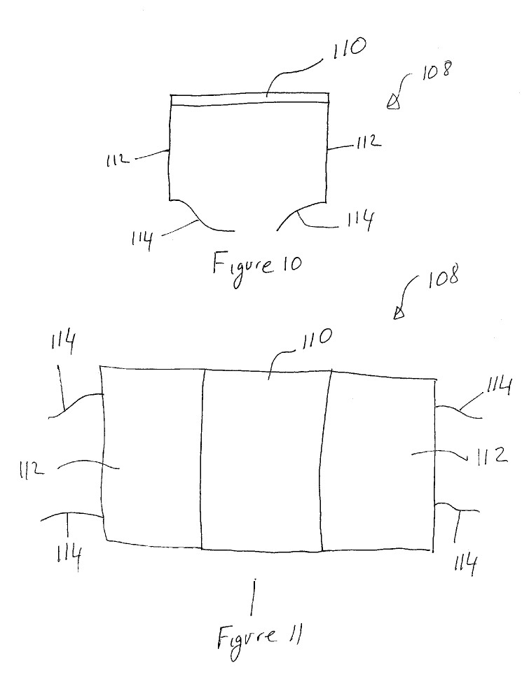

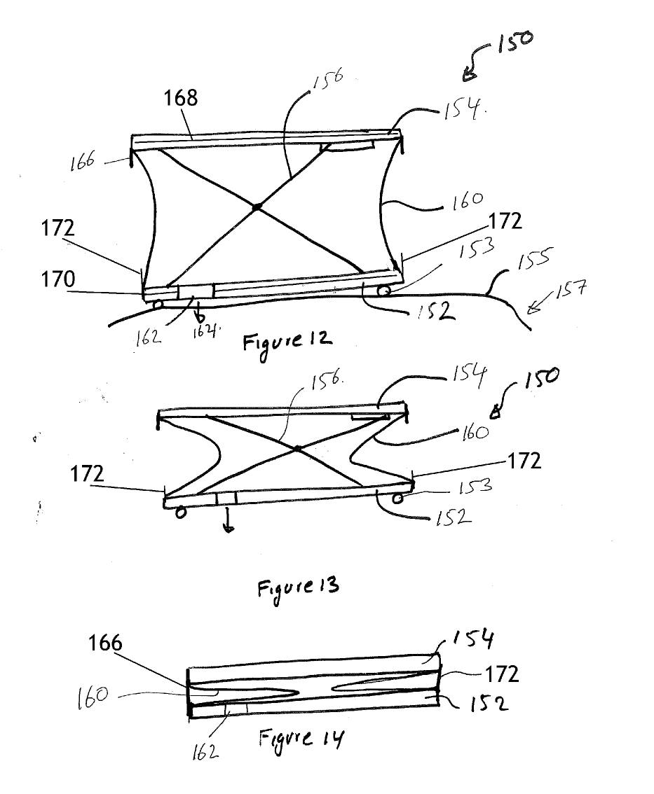

FIGS. 12 to 14 show an advertising device 150 according to a seventh embodiment of the invention. The structure is similar to that of FIG. 4 in that it is intended to be mounted on the roof or roof rack of a vehicle or on a trailer. The structure has a bottom member 152 for attaching to the roof 155 or roof rack 153 of a vehicle 157 (or a trailer) and a top member 154. The top member 154 is connected to bottom member 152 by a scissor lift 156 and is movable between an open position, shown in FIG. 12 and a closed position, shown in FIG. 14, in which the top and bottom members 154, 152 are next to each other. Although a single pair of arms are shown it will be appreciated that a scissor lift having multiple pairs of arms arrange end on end may be used.

Other lifting mechanisms, such as those described with reference to the other embodiments may be used to open and close the structure 150.

A flexible sheet material 160 is attached to and extends around the top 154 and bottom 152. The flexible sheet material 160 carries advertising or other messages, as previously described. In the open position the flexible material 160 is relatively taut. In the closed position the flexible material is folded inside the top and bottom members 154, 152, as shown in FIG. 14.

One of the issues with using flexible sheet material 160 is that as the device 150 is moved from an open position to a closed position the material 160 may bend or fold outwards of the top and bottom members 154, 152, rather than inwards.

The advertising device 150 includes a fan 162, preferably in the bottom member 152. The top and bottom members 154, 152 and the flexible material form a generally closed and relatively airtight structure. As an alternative the flexible material may extend across either of both the top and bottom members 154, 152, as indicted at 168 and 170 respectively, to form either a closed cell by itself or a cell closed by either of the top and bottom members 154, 152. During closing of the device the fan 162 is operated to draw air out of the interior of the structure, as indicated by arrow 164. This reduces the pressure inside the device and so the flexible material is causes the bend inward by the pressure difference, as seen in FIG. 13. As the device collapses the flexible material 160 continues to be drawn inwards. Thus the device may be closed and the flexible material does not extend out of the perimeter of the top and bottom members. Where the top member has a perimeter member 166 that extends downwards and overlaps the bottom member 152, this results in a quick and simple closure process, without the need to tuck the flexible material inside as the device is lowered. The bottom member 152 may have an upstanding perimeter wall 172 that in the closed position lies within the perimeter member 166.

If desired the fan 162 may be operated whilst the device is open so as to maintain a pressure defence and maintain the flexible material taut, so as to prevent or limit flapping due to the wind.

The flexible material may be a single sheet that extends around the perimeter of the top and bottom members or may be a number of panels joined together. Where the top and bottom members are polygons, such as a triangle or quadrilateral (such as a rectangle or truncated triangle), there may be separate panels for each side of the device. These panels may be joined together permanently, such as by stitching or may be joined temporally along adjacent edges by fasteners such as hook and loop fastener material. Where the top and bottom members define a circle, oval, ellipse or other closed curve without corners then a single sheet may be easily used.

The flexible material may be attached to the outside of one or both of the walls

It will be appreciated that the device does not need to be absolutely airtight. It is merely necessary that the fan be able to generate a suitable pressure difference. Of course, the more airtight the device the smaller the capacity of fan required.

The foregoing features of the embodiments of the invention may be combined in any combination of features where features are not mutually exclusive.

Unless the context clearly requires otherwise, throughout the description and any claims the words ‘comprise’, ‘comprising’, and the like are to be construed in an inclusive sense as opposed to an exclusive or exhaustive sense; that is to say, in the sense of “including, but not limited to”.

It will be apparent to those skilled in the art that many obvious modifications and variations may be made to the embodiments described herein without departing from the spirit or scope of the invention.

I claim:

1. An advertising device including:
a base member having a bottom perimeter;
a top member having a top perimeter;
at least one flexible display panel attached to the top and bottom members adjacent the first and second perimeters so as to extend between the top and bottom members;
a lift mechanism operable to move the top and bottom members between an open position in which at least a part of the top member is spaced from the bottom member and a closed position in which said at least a part of the top member is adjacent the bottom member;
the at least one flexible display panel defining at least part of a relatively airtight volume having an interior;
an air extractor in fluid communication with the interior and operative to extract air from the interior and create a low pressure in the interior to draw or maintain the at least one flexible display panel within a second volume defined by a surface extending from the top perimeter to the bottom perimeter as the top and bottom members are moved from the open position to the closed position.

2. The advertising device of claim 1 wherein the volume is defined in part by at least one of the top member and the bottom member.

3. The advertising device of claim 1 wherein the at least one flexible display panel defines all or substantially all of the volume.

4. The advertising device of claim 1 wherein the top member includes a top portion with a top perimeter wall defining the top perimeter extending from the top portion toward the bottom member.

5. The advertising device of claim 1 wherein the bottom member includes bottom portion with a bottom perimeter wall defining the bottom perimeter extending from the bottom portion toward the top member.

6. The advertising device of claim 1 wherein the top member includes a top portion with a top perimeter wall defining the top perimeter extending from the top portion toward the bottom member and the bottom member includes a bottom portion with a bottom perimeter wall defining the bottom perimeter extending from the bottom portion toward the top member.

7. The advertising device of claim 6 wherein in the closed position the top perimeter wall extends around the bottom perimeter wall to define a substantially closed box.

8. The advertising device of claim 1 wherein the top and bottom perimeters are substantially the same.

9. The advertising device of claim 1 wherein the top member includes a generally planar top portion.

10. The advertising device of claim 1 wherein the bottom member includes a generally planar bottom portion.

11. The advertising device of claim 1 wherein the top and bottom members move between open and closed positions by relative linear motion.

12. The advertising device of claim 1 wherein lift mechanism comprises a scissor lift.

13. The advertising device of claim 1 wherein in the open position all or substantially all of the at least one flexible display panel extending between the top and bottom members is held taut by the top and bottom members.

14. The advertising device of claim 1 wherein the at least one flexible display panel is attached to the top and bottom members within the top and bottom perimeters.

15. The advertising device of claim 1 wherein the top and bottom members move between open and closed positions by relative motion about an axis.

16. An advertising device including:
a bottom member;
a top member;
the bottom member having a bottom portion with a bottom perimeter wall defining a bottom perimeter extending from the bottom portion toward the top member;
a top member having a top portion with a top perimeter wall defining a top perimeter extending from the top portion toward the bottom member;
at least one flexible display panel attached to the top and bottom members adjacent the top and bottom perimeter walls so as to extend between the top and bottom members;
a scissor lift mechanism operable to move the top and bottom members between an open position in which at least a part of the top member is spaced from the bottom member and a closed position in which said at least a part of the top member is adjacent the bottom member;
the at least one flexible display panel and the top and bottom portions defining at least part of a relatively airtight volume having an interior;
an air extractor in fluid communication with the interior and operative to extract air from the interior and create a low pressure in the interior to draw or maintain the at least one flexible display panel within a second volume defined by a surface extending from the top perimeter to the bottom perimeter as the top and bottom members are moved from the open position to the closed position;
wherein in the open position all or substantially all of the at least one flexible display panel extending between the top and bottom members is held taut by the top and bottom members.

17. The advertising device of claim 16 wherein the at least one flexible display panel is connected to the top and bottom portions.

18. The advertising device of claim 16 wherein the top and bottom perimeters are substantially the same.

19. The advertising device of claim 16 wherein the top and bottom portions are generally parallel and move between the open and closed positions by movement generally perpendicular to the top and bottom portions.

20. The advertising device of claim 16 wherein the at least one flexible display panel is attached to the top and bottom members within the top and bottom perimeters.
